(19) United States
(12) Patent Application Publication
(10) Pub. No.: US 2002/0158432 A1
(43) Pub. Date: Oct. 31, 2002

(54) Infocart

(76) Inventor: Amir Waheed Wain, Foster City, CA (US)

Correspondence Address: AMIR W. WAIN, SUITE 100, 1730 S. AMPHLETT BLVD., SAN MATEO, CA, 94402, US

(21) Appl. No.: 09/844,990

(22) Filed: Apr. 30, 2001

(51) Int. Cl. B62D 39/00

(52) U.S. Cl. 280/33.992; 280/33.991

(57) ABSTRACT

Place active and dynamic electronic displays in front of shopping carts to attract customer attention. Content of these active displays can be changed quickly and easily. Information from central or local computer is transmitted through base stations to the display units using wireless technology. The computer uses an integrated software solution to manage and support signage management. The electronic displays have unique addresses therefore the system allows for transmission of information to single display units or groups of units. Display units may also store a set of pre-transmitted messages. Battery and power generator coupled to cart's wheel provide power to display units, eliminating need of battery replacement.

### BRIEF SUMMARY OF THE INVENTION

Placing wireless dynamic displays on front of shopping carts can attract customer attention. At present this location is used by a number of stores as static advertising space. Static signs being used are not so effective and changing information on these signs is a problem.

### DETAILED DESCRIPTION OF THE INVENTION

The idea is to place active and dynamic displays on front of shopping carts. Using wireless digital technology, content of these active displays is changed quickly and easily, as and when required by the store. These dynamic signs provide information such as advertising, targeted messages, store specials, news headlines, instructions, audio messages, images etc. to attract customer attention and convey pertinent information. These displays are animated which makes them even more effective. The messages on the display can also change depending on the location of the cart within the store.

Information from central or local computer is transmitted using wireless technology to the display units installed on the shopping carts. The display units receive information and display the messages on the screens. Display units may also store a set of pre-transmitted messages.

The computer utilizes a user-friendly, integrated software solution offering real-time management of dynamic screen displays and advertising content. The system supports signage management from end-to-end for the shopping cart displays. It can be used to control displays in a single retail store or an entire retail chain.

Communication between the computer and the display units is accomplished using a digital or analog transmission system based on wireless technology. Digital transmission protocol is designed to provide error free transmission of information to the displays. Typical installations consist of Base Stations that receive information from the computer and transmit to an acceptable range. The dynamic displays on the shopping carts may have unique addresses and only receive information that is specifically meant for that particular unit. The received information is deciphered and the new message is then displayed on the screen. This system allows for transmission of information to a single display unit or groups of units.

The display modules are of different types Alphanumeric or graphic, monochrome or color per the store requirement and display types available.

Battery and power generator coupled to the cart's wheels provide power to the display units. This eliminates the need of battery replacement and makes the product virtually maintenance free.

### InfoCart

Placing wireless dynamic displays on front of shopping carts can attract customer attention. At present this location is used by a number of stores as static advertising space. Static signs being used are not so effective and changing information on these signs is a problem.

The idea is to place an active and dynamic display at this location. Using wireless digital technology, content of these active displays is changed quickly and easily, as and when required by the store. These dynamic signs provide information such as advertising, targeted messages, store specials, news headlines, instructions, audio messages, images etc. to attract customer attention and convey pertinent information. These displays are animated which makes them even more effective. The messages on the display can also change depending on the location of the cart within the store.

Information from central or local computer is transmitted using wireless technology to the display units installed on the shopping carts. The display units receive information and display the messages on the screens. Display units may also store a set of pre-transmitted messages.

The computer utilizes a user-friendly, integrated software solution offering real-time management of dynamic screen displays and advertising content. The system supports signage management from end-to-end for the shopping cart displays. It can be used to control displays in a single retail store or an entire retail chain.

Communication between the computer and the display units is accomplished using a digital or analog transmission system based on wireless technology. Digital transmission protocol is designed to provide error free transmission of information to the displays. Typical installations consist of Base Stations that receive information from the computer and transmit to an acceptable range. The dynamic displays on the shopping carts may have unique addresses and only receive information that is specifically meant for that particular unit. The received information is deciphered and the new message is then displayed on the screen. This system allows for transmission of information to a single display unit or groups of units.

The display modules are of different types alphanumeric or graphic, monochrome or color per the store requirement and display types available:

Battery and power generator coupled to the cart's wheels provide power to the display units. This eliminates the need of battery replacement and makes the product virtually maintenance free.

1. The proposed utility patent makes the shopping cart an extremely effective advertising and information display medium.

2. Use of cart motion to power the display units eliminates the need of battery replacement and makes the product virtually maintenance free.

3. The system uses wireless technology. This allows the carts to be anywhere in or around the store and still receive information updates for the display units fixed on them. The information is transmitted from the computer that allows for real-time/dynamic updates. Message updates may also be triggered by cart location. Display units may also store a set of pre-transmitted messages.

4. Displays on the shopping carts can be updated individually or in groups. This allows for flexibility to have each shopping cart displaying a different message, groups of carts displaying different messages or all of them displaying the same message.
